(19) United States
(12) Patent Application Publication
(10) Pub. No.: US 2007/0285947 A1
(43) Pub. Date: Dec. 13, 2007

(54) KEYPAD BACKLIGHT ASSEMBLY FOR HANDHELD DEVICE USING LIGHT GUIDE PLATE

(75) Inventor: Woo-Chun Kim, Kyeongsangnam-Do (KR)

Correspondence Address: LAW OFFICE OF DELIO & PETERSON, LLC., 121 WHITNEY AVENUE, 3RD FLLOR, NEW HAVEN, CT, 06510, US

(73) Assignee: KBF CO., LTD., Kyeongsangnam-Do (KR)

(21) Appl. No.: 11/758,813

(22) Filed: Jun. 6, 2007

(30) Foreign Application Priority Data
Jun. 10, 2006 (KR) 52278/2006

(51) Int. Cl. F21V 7/04; F21V 33/00

(52) U.S. Cl. 362/631; 362/85; 362/612

(57) ABSTRACT

A keypad backlight assembly for a handheld device using a light guide plate positioned between a key sheet and a press contact sheet, thereby providing stability in structure, simplification in manufacturing process, and improvement in performance.

### BACKGROUND OF THE INVENTION

1. Field of the Invention

The present invention relates to a keypad backlight assembly for a handheld device using a light guide plate, and more particularly to a keypad backlight assembly for a handheld device using a light guide plate positioned between a key sheet and a press contact sheet, thereby providing stability in structure, simplification in manufacturing process, and improvement in performance.

2. Description of Related Art

A handheld device such as a mobile phone should be used at any situation or everywhere a user wants, such as at night or at a lightless place, so a lighting function of a keypad is very important.

However, a conventional light-emitting diode (LED) is problematic for the reasons of greater power consumption and inhomogeneous light emission along a distance of the LED. In addition, electroluminescence (EL) type light emission has problems of electric interference and relatively high costs.

To solve these conventional problems, the applicant has been studying the technology of adapting a light guide plate to a backlight assembly, and eventually has invented a keypad PCB integrated with a light guide plate (KR Patent Application. No. 10-2006-0037405).

The technology of light guide plate is very effective technology that guarantees homogeneous light emission, effective power saving, and economical cost reduction, thereby satisfying both aspects of performance and economy.

However, since the technology has a significant difference in effect dependent upon particular adapting structure and method of the light guide plate, continuous research is needed to improve a structure or a manufacturing process in order to maximize the effect.

### SUMMARY OF THE INVENTION

Accordingly, the present invention has been made to solve the above-mentioned problems occurring in the prior art, and the present invention provides a keypad backlight assembly for a handheld device using a light guide plate having a structure improving luminance, the homogeneity of light emission, and durability.

In order to accomplish the above object, in accordance with an aspect of the present invention, there is provided a keypad backlight assembly for a handheld device comprising: a printed circuit board (PCB) on which a light emitting diode (LED) is surface-mounted; a metal dome section coupled to the PCB and including metal dome parts and a dome tape fixing the same; a press contact section coupled onto the metal dome section and having, on a bottom face of an elastic plate body, protrusions corresponding to the metal dome parts; a light guide plate coupled onto the press contact section and having, on a bottom face of a light-propagating plate body, an uneven pattern part of an uneven reflecting structure and a through-hole; and a key sheet coupled onto the light guide plate, wherein the LED is positioned at a level that light from LED is directed to the bottom face of the light guide plate.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view of a keypad backlight assembly according to the present invention; and

FIG. 2 is a sectional view of the keypad backlight assembly according to the present invention.

### DETAILED DESCRIPTION OF THE EXEMPLARY EMBODIMENTS

Hereinafter, an exemplary embodiment of the present invention will be described with reference to the accompanying drawings.

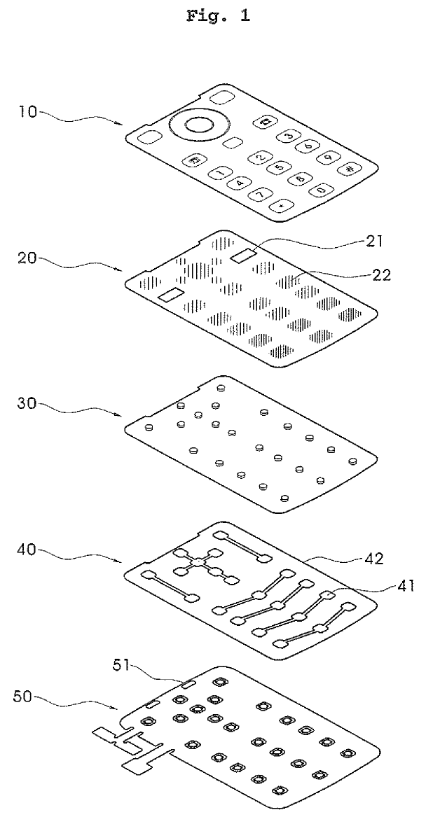

FIG. 1 is an exploded perspective view of a keypad backlight assembly according to the present invention, showing the constitutional elements of the assembly and the assembling order of the elements. The keypad backlight assembly generally includes a key sheet 10, a light guide plate 20, a press contact section 30, a metal dome section 40, and a printed circuit board (PCB).

The key sheet 10 is a panel type key sheet generally provided in an ultra thin mobile phone. The key sheet has a plurality of key parts, which are made from transparent material so as to perceive them upon light emission. The key sheet may be made in diverse shapes and from various materials according to the conventional technology.

The light guide plate 20 is a plate body for homogeneous diffusion of light incident from a light emitting diode (LED), and includes a through-hole 21, an uneven pattern part 22, and a circumferential light-shielding part (not shown).

The through-hole 21 is formed on a sheet of the light guide plate so as to allow light to pass through the through-hole. That is, the through-hole causes light loss to reduce the amount of light propagated, thereby improving the homogeneity of light emission dependent upon its proper position and shape according to structural features for each product.

The uneven pattern part 22 is an uneven part formed on a bottom face of the light guide plate for light propagation through reflection. The uneven part is provided at a position corresponding to the transparent key part of the key sheet by pressing process according to a predetermined pattern.

The pressing process can be done such that the light guide plate is directly pressed by a die, or otherwise, the light guide plate is first hard-coated, and the coating is then pressed.

The uneven pattern indicates a thing in which uneven reflecting structures cluster together so as to focus light upon the transparent parts of the key sheet. The unevenness itself may be diversely formed in conformity with a product's feature or design such as a dot or strip type. The unevenness can be designed such that as it is close to the LED, it is designed smaller and lower, allowing a lot of light to pass through, and as it is far away from the LED, it is designed larger and densely, allowing light to be preserved a lot through blocking the light propagation.

The circumferential light-shielding part prevents light loss through the side of the light guide plate, and allows light from LED to be directed well toward the pattern part of the light guide plate. In addition, while it is preferable that like the applicant's prior application, an LED cover covering the exposed LED is provided so as to shield light upward the light guide plate, according to the present invention, the key sheet is closely packed on the light guide plate so that it may be configured such that the key sheet covers the LED.

The press contact section 30 is an elastic plate body provided on the metal dome section. The press contact section includes, on a bottom face, an uneven structure having protrusions at positions corresponding to the metal dome parts. The press contact section serves to improve the touch and guide the accurate selection upon pressing the key by a user, and is made from a durable, elastic, adhesive material such as rubber.

Like this, the keypad is formed by assembling the key sheet 10, the light guide plate 20, and the press contact section 30 together, wherein the light guide plate is fixed between the key sheet and the press contact section, and the key sheet is closely packed on the light guide plate, serving as a light-shielding layer, so that post processes are provided stably and simplified, not only making the overall manufacturing process easy, but also securing durability and sufficient luminance (and homogeneity of light emission) of the light guide plate itself.

That is, since the light guide plate is positioned on a high layer of the press contact section, the light guide plate is structurally released from the local pressure of the press contact section, extending the lifetime of the light guide plate, and the light guide plate is free from the structural instability that the light guide plate has to be positioned over the metal dome section while maintaining a constant interval therebetween, thereby improving the durability of a product and simplifying the overall manufacturing process.

Further, since the light guide plate and the key sheet are in direct contact with each other, the amount of light emitted through the key sheet increases, and the homogeneity of light emission can be obtained through the through-hole.

The metal dome section 40 generally includes a metal dome part 41 and a dome tape 42 fixing the same, and is formed corresponding to the protrusions of the press contact section so as to transfer the user's key selection to the PCB, thereby serving as a switch for driving a circuit.
While the PCB 50 follows the prior technology, by nature of the present invention using the light guide plate, it is preferable to adopt the side-emitting LED in surface-mounting the LED 51 as to install to the end portion of the PCB, reducing the number of the LEDs.

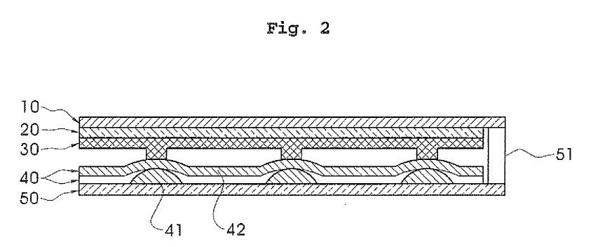

However, since light of LED has to be directed toward the light guide plate, as shown in FIG. 2, it is important to surface-mount the LED while properly adjusting the level of the LED 51. Herein, in order to allow light to be directed toward the light guide plate through surface-mounting the LED onto the PCB, it should be designed such that open space is formed at a portion where the metal dome section, the press contact section, and the light guide plate positioned on the PCB are overlapped with the LED, so that the LED is positioned there.

As set forth before, according to the present invention, the light guide plate is positioned between the key sheet and the press contact section to secure the structural stability, simplifying the manufacturing process, improving the durability of a product, and increasing the luminance of light.

Moreover, the amount of light propagated is controlled through the through-hole of the light guide plate, thereby controlling the homogeneity of light emission more precisely.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A keypad backlight assembly for a handheld device comprising:
a printed circuit board (PCB) on which a light emitting diode (LED) is surface-mounted;
a metal dome section coupled to the PCB and including metal dome parts and a dome tape fixing the same;
a press contact section coupled onto the metal dome section and having, on a bottom face of an elastic plate body, protrusions corresponding to the metal dome parts;
a light guide plate coupled onto the press contact section and having, on a bottom face of a light-propagating plate body, an uneven pattern part of an uneven reflecting structure and a through-hole; and
a key sheet coupled onto the light guide plate, wherein the LED is positioned at a level that light from LED is directed to the bottom face of the light guide plate.

2. The keypad backlight assembly as claimed in claim 1, wherein the metal dome section, the press contact section, and the light guide plate define open space at a portion where they are overlapped with the LED surface-mounted on the PCB, such that the LED is positioned in the space.
